(19) United States
(12) Patent Application Publication
(10) Pub. No.: US 2018/0304852 A1
(43) Pub. Date: Oct. 25, 2018

(54) SEAT BELT CUTTING DEVICE

(71) Applicant: Giovanni DI PIETRO, Valongo (PT)

(72) Inventor: Giovanni DI PIETRO, Valongo (PT)

(21) Appl. No.: 15/779,865

(22) PCT Filed: Dec. 30, 2016
(86) PCT No.: PCT/IB2016/058113

§ 371 Date: May 30, 2018

(30) Foreign Application Priority Data
Jan. 13, 2016 (PT) 109083

(51) Int. Cl. B60R 22/32; B26B 1/00

(52) U.S. Cl. CPC B60R 22/32; B60R 2022/328; B26B 1/00

(57) ABSTRACT

The present invention consists of a seat belt cutting device for land and air vehicles to be activated whenever the user is not able to unlock the locking system. It is inserted on the belt itself along which it slides, and is essentially characterized by comprising a body (1) through which the

belt (2) slides, provided with flaps (3) serving as guides for the belt and a hole (4) for the insertion of safety means, a cover (7) with a peripheral guide which engages with the flaps of the said lower body, which cover rotates on the said body, safety means (5) and a blade (6) embedded in the said cover.

### FIELD OF THE INVENTION

The present invention consists of a seat belt cutting device, applicable to all types of land and air vehicles.

### PRIOR ART

The seat belt constitutes an indispensable safety device for all passengers of all types of vehicles. It is a device to protect the occupants of transportation vehicles which is activated in the case of collision, preventing passengers from being projected out of the vehicle and/or their bodies from being projected against hard parts of the vehicle. Using a seat belt is in fact the cheapest and easiest means to avoid serious injuries in case of accident. Its use is mandatory in all vehicles.

However, there are some cases in which, after an accident takes place, the passenger is unable to unlock the seat belt locking system and consequently is not able to leave the vehicle. Indeed, there are a significant number of passengers who die in car accidents due to situations of not being able to free themselves from the seat belt.

The existing systems have disadvantages that are now intended to be minimized and/or overcome.

### SUMMARY OF THE INVENTION

The main objective of the invention is to create a device especially designed to allow a passenger with a fastened seat belt on, after an accident in which he cannot unlock the locking system, to be able to cut the said belt in a simple and safe way in order to leave the damaged vehicle.

Other objectives of the invention consist of designing a seat belt cutter which is assembled on the seat belt itself, cannot cause cutting accidents due to incorrect use and cannot be inadvertently activated.

Other objectives and advantages may be understood in the course of the following description and in the attached drawings, which, without limitation, represent:

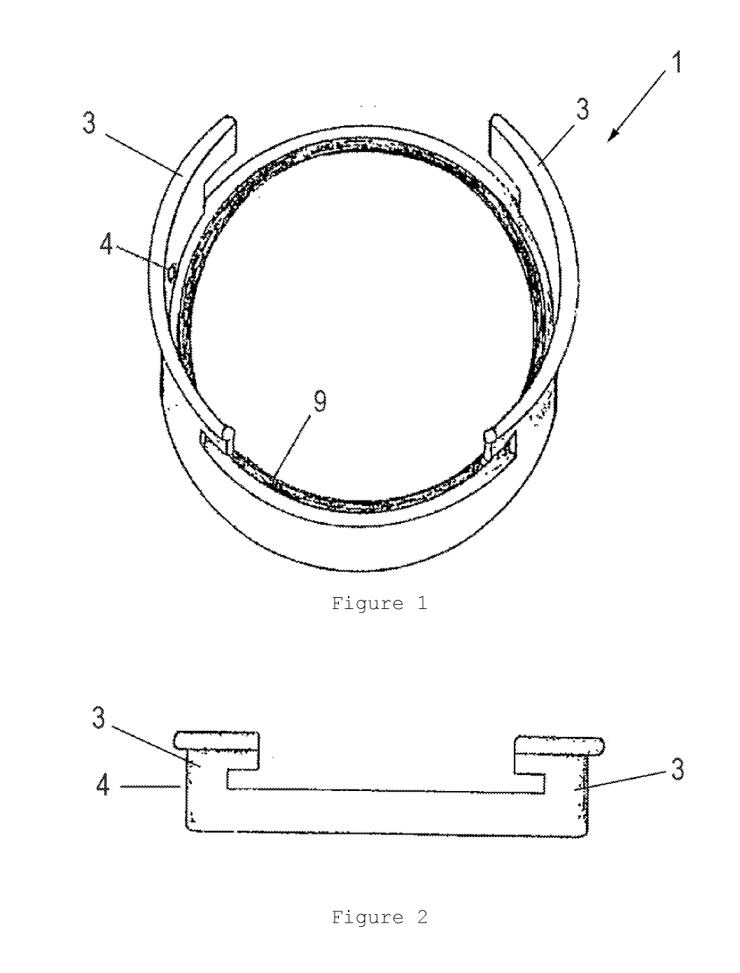

In FIG. 1, a perspective view of the body of the cutter;

In FIG. 2, a view in elevation of the body represented in FIG. 1;

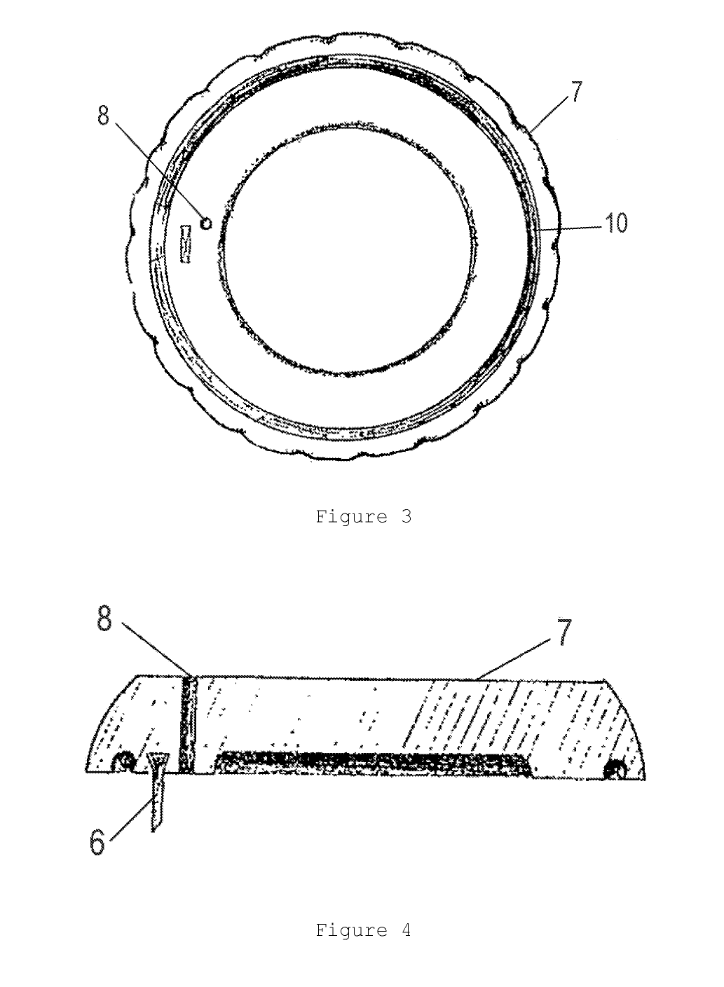

In FIG. 3, a plan view of the cover of the said body of the cutter;

In FIG. 4, a view in elevation of the said cover;

In FIG. 5, a perspective view of the safety means of the cutter;

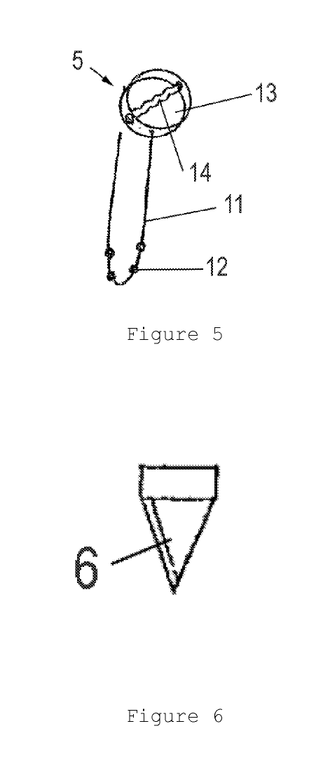

In FIG. 6, a plan view of the blade (6); and

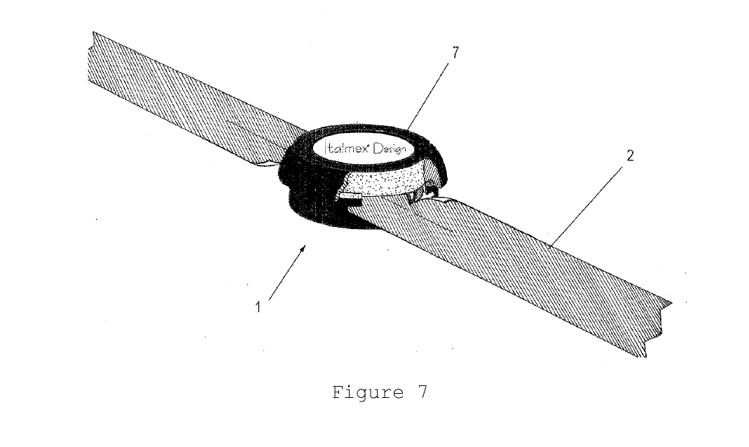

In FIG. 7, a perspective view of a seat belt with the cutting device of the invention, properly assembled.

### DETAILED DESCRIPTION OF AN EMBODIMENT OF THE PRESENT INVENTION

As may be observed in the figures, the cutting device of the invention is constituted by a body (1), a cover (7) of the body (1), a blade (6) and safety means (5).

The said body (1) constitutes the element through which the belt (2) slides. For this purpose, the body (1) is provided with two flaps (3) in which the belt sliding guides are configured. The body (1) also has a hole (4) to insert safety means and a guide (9) for the blade (6), as described below.

The cover (7) has on its lower side a flap (10) that guides the movement inside the flaps (3). On the upper side of the cover a hole (4) is provided for the passage of the safety means (5). The said cover (7) also has a blade (6) which is duly embedded in the cover, being embedded at the time of injection of the cover.

As may be understood from the foregoing description, the belt (2) is assembled in a sliding way in the body (1) and the cover (7) will fit onto the body with the possibility of rotation inside the flaps (3) of the body, which serve as a rotation guide for the said cover (7). The blade (6) “works” in a recess/guide (9) of the body (1). The assembly of the cover (7) on the body (1), after the fastening of the belt (2) in the respective sliding guide, prevents the belt, when being cut, from crumpling and forming wrinkles that would hinder the cutting action. This is possible given that the flap (10), once the cover is mounted on the body, will be placed immediately over the belt, not allowing it to form wrinkles.

The said blade (6), duly embedded in the cover (7), is a double-edged blade and it projects from the cover in order to fit into the guide of the body (1).

In case of inadvertent activation of the device and cutting of the belt, safety means (5) are provided. These are constituted preferably by a strap (11) that has small spheres (12) along its length and by a small circular part (13) with a hole (14) through which the said strap (11) passes. This strap, preferably of plastic material, preferably nylon, is inserted in the lateral hole (4) existing in the lateral wall of the body (1), in the hole (8) of the said cover (7) and in the hole (14) of the circular part (13). This part (13), which functions as a “seal”, contains in its hole (14) small grooves to prevent the sliding of the strap (11), i.e. to retain the small spheres (12).

Once the whole device has been mounted, the user/passenger can rotate the cover on the body, breaking the safety seal and cutting the belt. It can be rotated in any direction. Rotation and the corresponding cutting cannot occur inadvertently because it is necessary to exert some force for the strap (11) to be pulled and cut from the safety means (5). Therefore, it is very difficult for a child to activate the cutting device. In other words, the activation of the device always requires a deliberate action. Until the breaking of the safety seal, i.e. of the strap (11) of the part (13), the cover cannot be easily rotated on the body to proceed with the cutting of the belt.

In addition, the components of the device described above are preferably of plastic material, preferably polyurethane, with a circular configuration, and their dimensions will be suitable for the seat belts to which they are applied.

1. Seat belt cutting device for all types of land and air vehicles that use seat belts, which is to be activated in case of accident whenever the user is not able to unlock the locking system and which is inserted on the belt itself, along which it slides, characterized by comprising:
a body (1) through which the belt (2) slides, provided with two flaps (3) that form guides for the sliding of the belt and a hole (4) for the insertion of safety means;
a cover (7) provided with a flap (10) that functions as a peripheral guide and engages with the flaps (3) of the said lower body, which cover rotates on the said body, and a hole (8) for the passage of safety means (5);
safety means (5); and
a blade (6) embedded in the said cover (7) so as to project from the lower part of the cover.

2. Seat belt cutting device, according to claim 1, characterized in that the said cover (7) fits onto the said body (1) with the possibility of rotation inside the flaps (3) of the body, the said flaps serving as a rotation guide for the said cover (7).

3. Seat belt cutting device, according to claim 1, characterized in that the assembly of the cover (7) on the body (1), after the fastening of the belt (2) in the respective sliding guide, prevents the belt, when being cut, from crumpling and forming wrinkles that would hinder the cutting action.

4. Seat belt cutting device, according to claim 1, characterized in that the said body (1) is provided with a recess/guide (9) for the blade (6) in such a way that, when the said cover (7) is rotated, the said blade (6) moves peripherally in order to perform the cutting of the belt (2).

5. Seat belt cutting device, according to claim 1, characterized in that the blade (6) “works” in a recess/guide (9) of the body (1)

6. Seat belt cutting device, according to claim 5, characterized in that the blade (6) is a double-edged blade.

7. Seat belt cutting device, according to claim 6, characterized in that the safety means are constituted preferably by a strap (11) that has small spheres (12) along its length and by a small circular part (13) with a hole (14) through which the said strap (11) passes.

8. Seat belt cutting device, according to claim 7, characterized in that the said strap (11) is preferably made of plastic material, preferably nylon

9. Seat belt cutting device, according to claim 1, characterized in that the said strap (11) is inserted in the lateral hole (4) existing in the lateral wall of the body (1), in the hole (8) of the said cover (7) and in the hole (14) of the circular part (13).

10. Seat belt cutting device, according to claim 1, characterized in that the said hole (14) of the part (13) contains small grooves to retain the small spheres (12).

11. Seat belt cutting device, according to claim 1, characterized in that the cutting of the belt (2) takes place after the strap (11) is pulled out of the circular part whenever the user rotates the said cover (7) on the body (1).

12. Seat belt cutting device, according to claim 1, characterized in that the rotation of the constituent parts (1 and 7) is performed to the right or to the left.

13. Seat belt cutting device, according to claim 1, characterized in that the body (1) and the cover (7) are circular.
